(19) United States
(12) Patent Application Publication
(10) Pub. No.: US 2025/0076641 A1
(43) Pub. Date: Mar. 6, 2025

(54) OPTICAL EYE TRACKING SYSTEMS AND METHODS

(71) Applicant: Valve Corporation, Bellevue, WA (US)

(72) Inventors: Joshua Mark Hudman, Issaquah, WA (US); Hans Gunther VanderWel, Kirkland, WA (US)

(21) Appl. No.: 18/461,295

(22) Filed: Sep. 5, 2023

(51) Int. Cl. G02B 27/00; B29C 45/16; B29D 11/00; G02B 6/10; G06F 1/16; G06F 3/01

(52) U.S. Cl. CPC G02B 27/0093; B29C 45/16; B29D 11/00009; B29D 11/00663; G02B 6/102; G06F 1/163; G06F 3/013; B29K 2033/12; B29K 2269/00; B29K 2309/08; B29K 2995/0025; B29K 2995/0027; B29L 2011/0016

(57) ABSTRACT

An eye tracking system for a head-mounted display (HMD) device. The system includes a lens assembly, an optical tube assembly, and an optical light guide. The optical tube assembly is coupled to the lens assembly, supporting the lens assembly and ensuring optical alignment with a display panel of the HMD device. The lens assembly is positioned close to the front end of the optical tube assembly, which is near the user's eye during use. The optical light guide transports light and is coupled to the optical tube assembly. The optical light guide includes a light input feature positioned rearward of the front end of the optical tube assembly that is configured to receive light from a light source. The optical light guide also includes a plurality of light output features positioned proximate to the front end of the optical tube assembly.

### BACKGROUND

The present disclosure relates generally to eye tracking systems and, more specifically, to an improved eye tracking system for use in head-mounted display (HMD) devices, such as virtual reality (VR) and augmented reality (AR) headsets.

Eye tracking systems are essential components of various applications, including human-machine interaction, gaze-based control, gaming, and research in fields like psychology, neuroscience, and marketing. In recent years, the demand for accurate and reliable eye tracking systems has increased significantly with the growing popularity of VR and AR technologies. These head-mounted display devices require precise eye tracking to deliver a seamless and immersive user experience.

One approach to eye tracking is glint detection, which involves the use of infrared (IR) light-emitting diodes (LEDs) to illuminate the user's eye. The IR light reflects off the cornea and creates a pattern of glints, which are captured by an optical sensor, such as a camera. The position and orientation of the glints can be analyzed to determine the user's gaze direction and point of focus.

### BRIEF DESCRIPTION OF THE DRAWINGS

Aspects of the present disclosure are best understood from the following detailed description when read with the accompanying figures. It is noted that, in accordance with the standard practice in the industry, various features may not be drawn to scale. In fact, the dimensions of the various features may be arbitrarily increased or reduced for clarity of discussion.

FIG. 1 is a schematic diagram of a networked environment that includes one or more systems suitable for performing at least some techniques described in the present disclosure, including embodiments of an eye tracking subsystem.

FIG. 2 is a diagram illustrating an example environment in which at least some of the described techniques are used with an example head-mounted display device that is tethered to a video rendering computing system and providing a virtual reality display to a user.

FIG. 3 is a schematic diagram illustrating an exemplary head-mounted display device incorporating the improved eye tracking system in accordance with an embodiment of the present disclosure.

FIG. 4 is an exploded schematic diagram of the head-mounted display device shown in FIG. 3, showing various components thereof including an optical tube assembly of a head-mounted display device.

FIG. 5A is a top, front-left perspective view of an optical tube assembly and eye tracking system of the head-mounted display device of FIG. 3.

FIG. 5B is a top, rear-right perspective view of the optical tube assembly and eye tracking system of the head-mounted display device of FIG. 3.

FIG. 5C is a rear side elevational view of the optical tube assembly and eye tracking system of the head-mounted display device of FIG. 3.

FIG. 5D is a top plan view of the optical tube assembly and eye tracking system of the head-mounted display device of FIG. 3.

FIG. 5E is a right side elevational view of the optical tube assembly and eye tracking system of the head-mounted display device of FIG. 3.

FIG. 5F is bottom plan view of the optical tube assembly and eye tracking system of the head-mounted display device of FIG. 3.

FIG. 6 is a front-right perspective view of the optical tube assembly and eye tracking system of the head-mounted display device of FIG. 3.

FIG. 7 is an elevational view of the optical tube assembly and eye tracking system of the head-mounted display device of FIG. 3, showing light from an optical light guide being transmitted in a direction toward a user's eye during use of the head-mounted display device.

FIG. 8 is a front-right perspective view of the optical tube assembly and eye tracking system of the head-mounted display device of FIG. 3, showing light from an optical light guide being transmitted in a direction toward a user's eye during use of the head-mounted display device.

FIG. 9 is a sectional view of the optical tube assembly and eye tracking system of the head-mounted display device of FIG. 3, showing light from an optical light guide being transmitted in a direction toward a user's eye during use of the head-mounted display device.

FIG. 10 is a rear side perspective view of the optical tube assembly and eye tracking system of the head-mounted display device of Figure, showing light from an optical light guide being transmitted in a direction toward a user's eye during use of the head-mounted display device.

FIG. 11 is a perspective view of another embodiment of a front end of an optical tube assembly, according to one non-limiting illustrated implementation.

FIG. 12 is a perspective view of another embodiment of a front end of an optical tube assembly, according to one non-limiting illustrated implementation.

FIG. 13 is a perspective view of another embodiment of a front end of an optical tube assembly, according to one non-limiting illustrated implementation.

FIG. 14 is an interior view of an optical light guide of the optical tube assembly shown in FIG. 13, according to one non-limiting illustrated implementation.

FIG. 15 is disassembled view of the optical tube assembly shown in FIG. 13.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification t-o “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

The present disclosure is directed to systems and methods for eye tracking, including an eye tracking system for a head-mounted display (HMD) device. In at least some implementations, the system includes a lens assembly, an optical tube assembly, and an optical light guide. The optical tube assembly is mechanically coupled to the lens assembly, supporting the lens assembly, and ensuring optical alignment with a display panel of the HMD device. The lens assembly is positioned close to a front end of the optical tube assembly that is near the user's eye during use of the HMD device. The optical light guide is operative to transport light, and is mechanically coupled to the optical tube assembly. In at least some implementations, the optical light guide may be formed with the optical tube assembly via a double shot injection molding process. The optical light guide includes one or more light input features positioned rearward of the front end of the optical tube assembly. The light input features are configured to receive light from one or more light sources, such as one or more infrared (IR) light emitting diodes (LEDs). The optical light guide also includes a plurality of light output features spaced apart from each other and positioned proximate to the front end of the optical tube assembly. Each of the light output features is configured to allow light inside the optical light guide to exit the optical light guide toward the user's eye during use of the HMD device. The light reflected off of the user's eye may be captured by an optical sensor (e.g., camera), and the sensor data may be processed to determine the gaze direction of the user.

The eye tracking systems described herein enhance the user experience by providing accurate eye tracking, enabling a more immersive and interactive experience within the virtual environment, and facilitating applications such as gaze-based navigation and control, user attention analysis, and realistic eye behavior simulation.

Eye tracking is a process by which the position, orientation, or motion of the eye may be measured, detected, sensed, determined, or monitored (collectively, “measured”). In many applications, this is done with a view towards determining the gaze direction of a user. The position, orientation, or motion of the eye may be measured in a variety of different ways, the least invasive of which may employ one or more optical detectors or sensors to optically track the eye. Some techniques may involve illuminating one or more portions of the user's eye, all at once, with infrared light and measuring reflections (e.g., glints) with at least one optical sensor, such as a camera, which is tuned to be sensitive to the infrared light. Information about how the infrared light is reflected from the eye is analyzed to determine the positions, orientations, and/or motions of one or more eye features such as the cornea, pupil, iris, or retinal blood vessels.

Eye tracking functionality is highly advantageous in applications of wearable head-mounted display systems. Some examples of the utility of eye tracking in head-mounted display system include influencing where content is displayed in the user's field of view, conserving power, bandwidth, or computational resources by modifying the display of content that is outside of the user's field of view (e.g., foveated rendering), influencing what content is displayed to the user, determining where the user is looking or gazing, determining whether the user is looking at displayed content on a display, providing a method through which the user may control or interact with displayed content, and other applications.

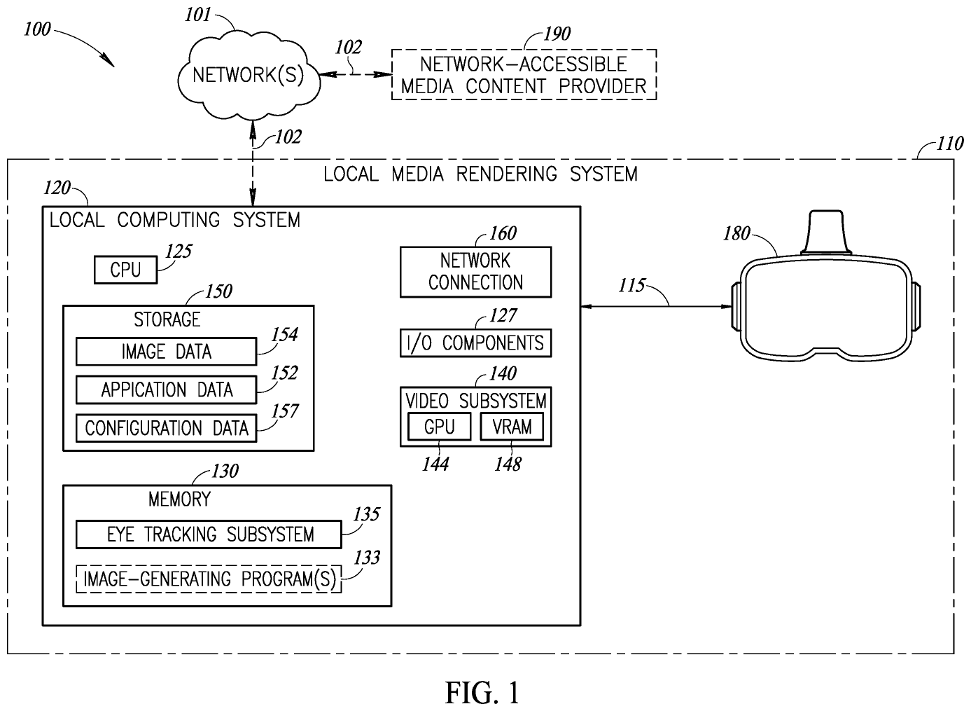

The present disclosure relates generally to techniques for eye tracking, including mechanical structures and other components used for eye tracking. Such techniques may be used, for example, in a head-mounted display (“HMD”) device used for VR or AR applications. Some or all of the techniques described herein may be performed via automated operations of embodiments of an eye tracking subsystem, such as implemented by one or more configured hardware processors and/or other configured hardware circuitry. The one or more hardware processors or other configured hardware circuitry of such a system or device may include, for example, one or more GPUs (“graphical processing units”) and/or CPUs (“central processing units”) and/or other microcontrollers (“MCUs”) and/or other integrated circuits, such as with the hardware processor(s) being part of an HMD device or other device that incorporates one or more display panels on which the image data will be displayed or being part of a computing system that generates or otherwise prepares the image data to be sent to the display panel(s) for display, as discussed further below. More generally, such a hardware processors or other configured hardware circuitry may include, but are not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), digital signal processors (DSPs), programmable logic controllers (PLCs), etc. Additional details are included elsewhere herein, including with respect to FIG. 1 discussed below.

Technical benefits in at least some embodiments of the described techniques may include addressing and mitigating increased media transmission bandwidths for image encoding by reducing image data size, improving speed of controlling display panel pixels (e.g., based at least in part on corresponding reduced image data size), improving foveated image systems and other techniques that reflect subsets of display panels and/or images of particular interest, etc. Foveated image encoding systems take advantage of particular aspects of the human visual system (which may provide detailed information only at and around a point of focus), but often use specialized computational processing in order to avoid visual artifacts to which peripheral vision is very sensitive (e.g., artifacts related to motion and contrast in video and image data). In cases of certain VR and AR displays, both the bandwidth and computing usage for processing high resolution media are exacerbated because a particular display device involves two separate display panels (i.e., one for each eye) with two separately addressable pixel arrays, each involving an appropriate resolution. Thus, the described techniques may be used, for example, for decreasing the transmission bandwidth for local and/or remote display of a video frame or other image, while preserving resolution and detail in a viewer's “area of interest” within an image while also minimizing computing usage for processing such image data. Furthermore, the use of lenses in head-mounted display devices and with other displays may provide a greater focus or resolution on a subset of the display panel, such that using such techniques to display lower-resolution information in other portions of the display panel may further provide benefits when using such techniques in such embodiments.

For illustrative purposes, some embodiments are described below in which specific types of information are acquired and used in specific types of ways for specific types of structures and by using specific types of devices. However, it will be understood that such described techniques may be used in other manners in other embodiments, and that the present disclosure is thus not limited to the exemplary details provided. As one non-exclusive example, various of the embodiments discussed herein include the use of images that are video frames-however, while many examples described herein refer to a “video frame” for convenience, it will be appreciated that the techniques described with reference to such examples may be employed with respect to one or more images of various types, including non-exclusive examples of multiple video frames in succession (e.g., at 30, 60, 90, 180 or some other quantity of frames per second), other video content, photographs, computer-generated graphical content, other articles of visual media, or some combination thereof. In addition, various details are provided in the drawings and text for exemplary purposes, but are not intended to limit the scope of the present disclosure. In addition, as used herein, a “pixel” refers to the smallest addressable image element of a display that may be activated to provide all possible color values for that display. In many cases, a pixel includes individual respective sub-elements (in some cases as separate “sub-pixels”) for separately producing red, green, and blue light for perception by a human viewer, with separate color channels used to encode pixel values for the sub-pixels of different colors. A pixel “value” as used herein refers to a data value corresponding to respective levels of stimulation for one or more of those respective RGB elements of a single pixel.

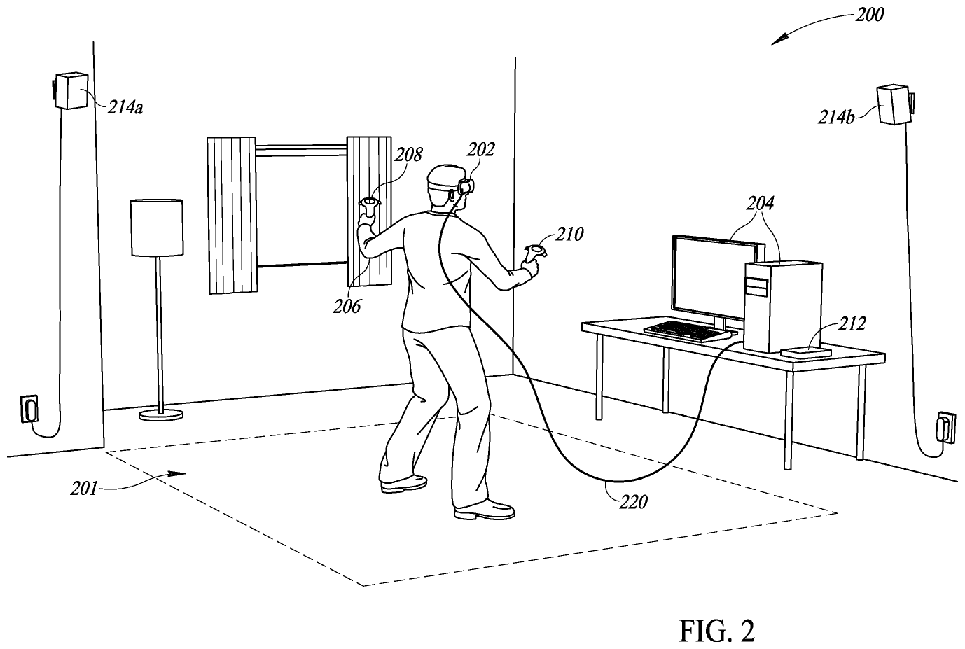

FIG. 1 is a schematic diagram of a networked environment 100 that includes a local media rendering (LMR) system 110 (e.g., a gaming system), which includes a local computing system 120 and display device 180 (e.g., an HMD device with two display panels) suitable for performing at least some techniques described herein. In the depicted embodiment of FIG. 1, the local computing system 120 is communicatively connected to display device 180 via transmission link 115 (which may be wired or tethered, such as via one or more cables as illustrated in FIG. 2 (cable 220), or instead may be wireless). In other embodiments, the local computing system 120 may provide encoded image data for display to a panel display device (e.g., a TV, console or monitor) via a wired or wireless link, whether in addition to or instead of the HMD device 180, and the display devices each includes one or more addressable pixel arrays. In various embodiments, the local computing system 120 may include a general purpose computing system; a gaming console; a video stream processing device; a mobile computing device (e.g., a cellular telephone, PDA, or other mobile device); a VR or AR processing device; or other computing system.

In the illustrated embodiment, the local computing system 120 has components that include one or more hardware processors (e.g., centralized processing units, or “CPUs”) 125, memory 130, various I/O (“input/output”) hardware components 127 (e.g., a keyboard, a mouse, one or more gaming controllers, speakers, microphone, IR transmitter and/or receiver, etc.), a video subsystem 140 that includes one or more specialized hardware processors (e.g., graphics processing units, or “GPUs”) 144 and video memory (VRAM) 148, computer-readable storage 150, and a network connection 160. Also in the illustrated embodiment, an embodiment of an eye tracking subsystem 135 executes in memory 130 in order to perform at least some of the described techniques, such as by using the CPU(s) 125 and/or GPU(s) 144 to perform automated operations that implement those described techniques, and the memory 130 may optionally further execute one or more other programs 133 (e.g., to generate video or other images to be displayed, such as a game program). As part of the automated operations to implement at least some techniques described herein, the eye tracking subsystem 135 and/or programs 133 executing in memory 130 may store or retrieve various types of data, including in the example database data structures of storage 150, in this example, the data used may include various types of image data information in database (“DB”) 154, various types of application data in DB 152, various types of configuration data in DB 157, and may include additional information, such as system data or other information.

The LMR system 110 is also, in the depicted embodiment, communicatively connected via one or more computer networks 101 and network links 102 to an exemplary network-accessible media content provider 190 that may further provide content to the LMR system 110 for display, whether in addition to or instead of the image-generating programs 133. The media content provider 190 may include one or more computing systems (not shown) that may each have components similar to those of local computing system 120, including one or more hardware processors, I/O components, local storage devices and memory, although some details are not illustrated for the network-accessible media content provider for the sake of brevity.

It will be appreciated that, while the display device 180 is depicted as being distinct and separate from the local computing system 120 in the illustrated embodiment of FIG. 1, in certain embodiments some or all components of the local media rendering system 110 may be integrated or housed within a single device, such as a mobile gaming device, portable VR entertainment system, HMD device, etc. In such embodiments, transmission link 115 may, for example, include one or more system buses and/or video bus architectures.

As one example involving operations performed locally by the local media rendering system 120, assume that the local computing system is a gaming computing system, such that application data 152 includes one or more gaming applications executed via CPU 125 using memory 130, and that various video frame display data is generated and/or processed by the image-generating programs 133, such as in conjunction with GPU 144 of the video subsystem 140. In order to provide a quality gaming experience, a high volume of video frame data (corresponding to high image resolution for each video frame, as well as a high “frame rate” of approximately 60-180 of such video frames per second) is generated by the local computing system 120 and provided via the wired or wireless transmission link 115 to the display device 180.

It will also be appreciated that computing system 120 and display device 180 are merely illustrative and are not intended to limit the scope of the present disclosure. The computing system 120 may instead include multiple interacting computing systems or devices, and may be connected to other devices that are not illustrated, including through one or more networks such as the Internet, via the Web, or via private networks (e.g., mobile communication networks, etc.). More generally, a computing system or other computing node may include any combination of hardware or software that may interact and perform the described types of functionality, including, without limitation, desktop or other computers, game systems, database servers, network storage devices and other network devices, PDAs, cell phones, wireless phones, pagers, electronic organizers, Internet appliances, television-based systems (e.g., using set-top boxes and/or personal/digital video recorders), and various other consumer products that include appropriate communication capabilities. The display device 180 may similarly include one or more devices with one or more display panels of various types and forms, and optionally include various other hardware and/or software components.

In addition, the functionality provided by the eye tracking subsystem 135 may in some embodiments be distributed in one or more components, and in some embodiments some of the functionality of the eye tracking subsystem 135 may not be provided and/or other additional functionality may be available. It will also be appreciated that, while various items are illustrated as being stored in memory or on storage while being used, these items or portions of them may be transferred between memory and other storage devices for purposes of memory management or data integrity. Thus, in some embodiments, some or all of the described techniques may be performed by hardware that include one or more processors or other configured hardware circuitry or memory or storage, such as when configured by one or more software programs (e.g., by the eye tracking subsystem 135 or it components) and/or data structures (e.g., by execution of software instructions of the one or more software programs and/or by storage of such software instructions and/or data structures). Some or all of the components, systems and data structures may also be stored (e.g., as software instructions or structured data) on a non-transitory computer-readable storage medium, such as a hard disk or flash drive or other non-volatile storage device, volatile or non-volatile memory (e.g., RAM), a network storage device, or a portable media article to be read by an appropriate drive (e.g., a DVD disk, a CD disk, an optical disk, etc.) or via an appropriate connection. The systems, components and data structures may also in some embodiments be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

FIG. 2 illustrates an example environment 200 in which at least some of the described techniques are used with an example HMD device 202 that is coupled to a video rendering computing system 204 via a tethered connection 220 (or a wireless connection in other embodiments) to provide a virtual reality display to a human user 206. The user wears the HMD device 202 and receives displayed information via the HMD device from the computing system 204 of a simulated environment different from the actual physical environment, with the computing system acting as an image rendering system that supplies images of the simulated environment to the HMD device for display to the user, such as images generated by a game program and/or other software program executing on the computing system. The user is further able to move around within a tracked volume 201 of the actual physical environment 200 in this example, and may further have one or more I/O (“input/output”) devices to allow the user to further interact with the simulated environment, which in this example includes hand-held controllers 208 and 210.

In the illustrated example, the environment 200 may include one or more base stations 214 (two shown, labeled base stations 214a and 214b) that may facilitate tracking of the HMD device 202 or the controllers 208 and 210. As the user moves location or changes orientation of the HMD device 202, the position of the HMD device is tracked, such as to allow a corresponding portion of the simulated environment to be displayed to the user on the HMD device, and the controllers 208 and 210 may further employ similar techniques to use in tracking the positions of the controllers (and to optionally use that information to assist in determining or verifying the position of the HMD device). After the tracked position of the HMD device 202 is known, corresponding information is transmitted to the computing system 204 via the tether 220 or wirelessly, which uses the tracked position information to generate one or more next images of the simulated environment to display to the user.

There are numerous different methods of positional tracking that may be used in the various implementations of the present disclosure, including, but not limited to, acoustic tracking, inertial tracking, magnetic tracking, optical tracking, combinations thereof, etc.

In at least some implementations, the HMD device 202 may include one or more optical receivers or sensors that may be used to implement tracking functionality or other aspects of the present disclosure. For example, the base stations 214 may each sweep an optical signal across the tracked volume 201. Depending on the requirements of each particular implementation, each base station 214 may generate more than one optical signal. For example, while a single base station 214 is typically sufficient for six-degree-of-freedom tracking, multiple base stations (e.g., base stations 214a, 214b) may be necessary or desired in some embodiments to provide robust room-scale tracking for HMD devices and peripherals. In this example, optical receivers are incorporated into the HMD device 202 and or other tracked objects, such as the controllers 208 and 210. In at least some implementations, optical receivers may be paired with an accelerometer and gyroscope Inertial Measurement Unit (“IMU”) on each tracked device to support low-latency sensor fusion.

In at least some implementations, each base station 214 includes two rotors which sweep a linear beam across the tracked volume 201 on orthogonal axes. At the start of each sweep cycle, the base station 214 may emit an omni-directional light pulse (referred to as a “sync signal”) that is visible to all sensors on the tracked objects. Thus, each sensor computes a unique angular location in the swept volume by timing the duration between the sync signal and the beam signal. Sensor distance and orientation may be solved using multiple sensors affixed to a single rigid body.

The one or more sensors positioned on the tracked objects (e.g., HMD device 202, controllers 208 and 210) may comprise an optoelectronic device capable of detecting the modulated light from the rotor. For visible or near-infrared (NIR) light, silicon photodiodes and suitable amplifier/detector circuitry may be used. Because the environment 200 may contain static and time-varying signals (optical noise) with similar wavelengths to the signals of the base stations 214 signals, in at least some implementations the base station light may be modulated in such a way as to make it easy to differentiate from any interfering signals, and/or to filter the sensor from any wavelength of radiation other than that of base station signals.

Inside-out tracking is also a type positional tracking that may be used to track the position of the HMD device 202 and/or other objects (e.g., controllers 208 and 210, tablet computers, smartphones). Inside-out tracking differs from outside-in tracking by the location of the cameras or other sensors used to determine the HMD's position. For inside-out tracking, the camera or sensors are located on the HMD, or object being tracked, while in outside-out tracking the camera or sensors are placed in a stationary location in the environment.

An HMD that utilizes inside-out tracking utilizes one or more cameras to “look out” to determine how its position changes in relation to the environment. When the HMD moves, the sensors readjust their place in the room and the virtual environment responds accordingly in real-time. This type of positional tracking can be achieved with or without markers placed in the environment. The cameras that are placed on the HMD observe features of the surrounding environment. When using markers, the markers are designed to be easily detected by the tracking system and placed in a specific area. With “markerless” inside-out tracking, the HMD system uses distinctive characteristics (e.g., natural features) that originally exist in the environment to determine position and orientation. The HMD system's algorithms identify specific images or shapes and use them to calculate the device's position in space. Data from accelerometers and gyroscopes can also be used to increase the precision of positional tracking.

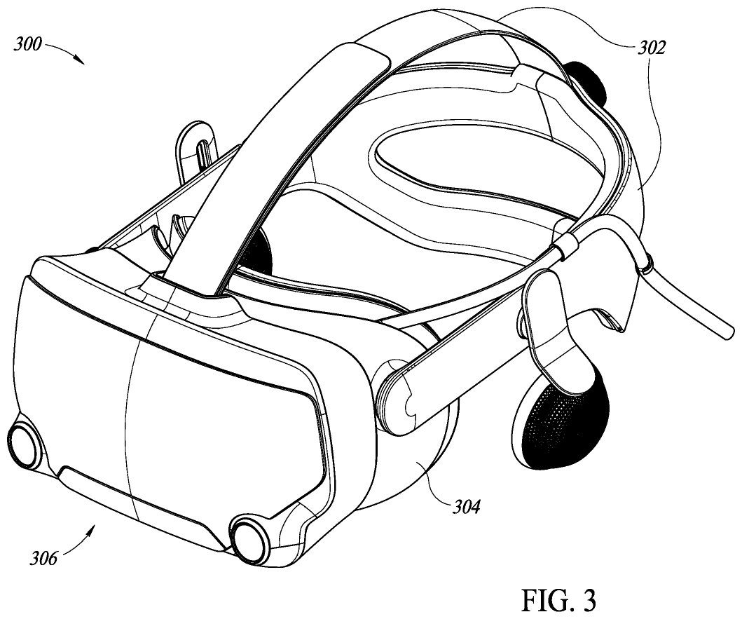

FIG. 3 shows an exterior of an HMD device 300 according to one or more embodiments. The HMD device 300 includes a set of straps 302 attached to a main body 304. The set of straps 302 are useable to selectively and securely mount the HMD device 300 to the head of a user for viewing visual content.

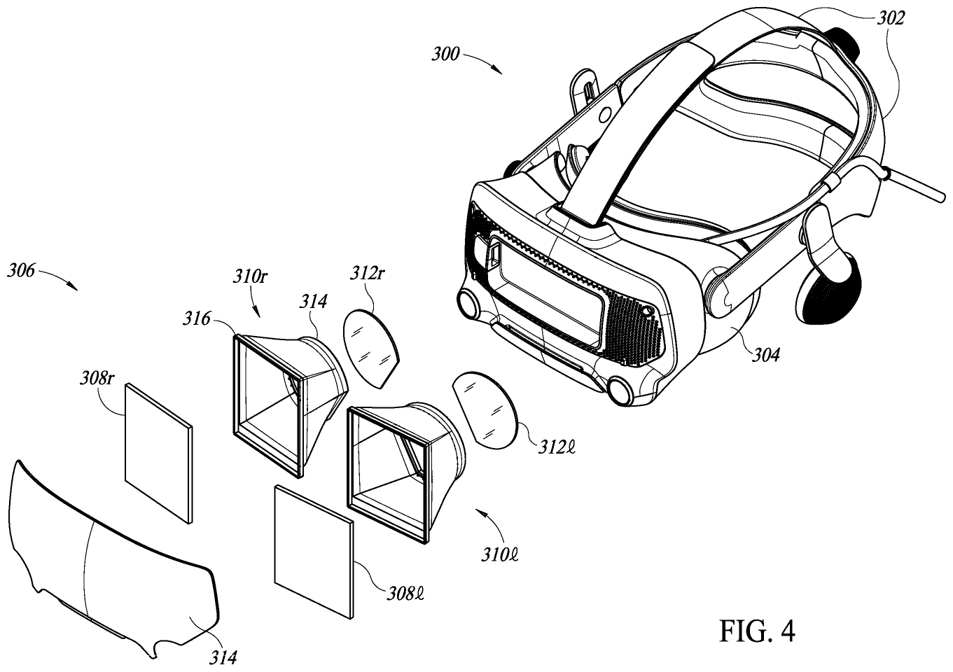

As shown in FIG. 4, the main body 304 includes a front portion 306 that houses left and right display panels 3081 and 308r, left and right optical tube assemblies 3101 and 310r, left and right lens assemblies 3121 and 312r, and a front cover 314.

The HMD device 300 may include a front-facing or forward camera and a plurality of sensors of one or more types. As one example, some or all of the sensors may assist in determining the location and orientation of the device 300 in space, such as light sensors to detect and use light information emitted from one or more external devices (not shown, e.g., base stations 214 of FIG. 2). The forward camera and the sensors may be directed forward toward an actual scene or environment (not shown) in which the user operates the HMD device 300. The actual physical environment may include, for example, one or more objects (e.g., walls, ceilings, furniture, stairs, cars, trees, tracking markers, or any other types of objects).

The HMD device 300 may further include one or more additional components that are not attached to the front-facing structure (e.g., are internal to the HMD device), such as an IMU (inertial measurement unit) electronic device that measures and reports the HMD device's 300 specific force, angular rate, and/or the magnetic field surrounding the HMD device (e.g., using a combination of accelerometers and gyroscopes, and optionally, magnetometers).

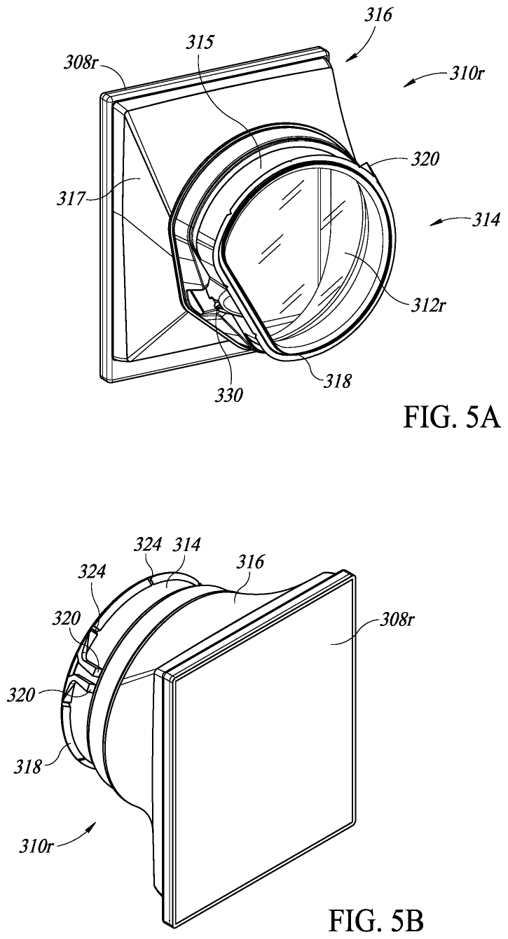

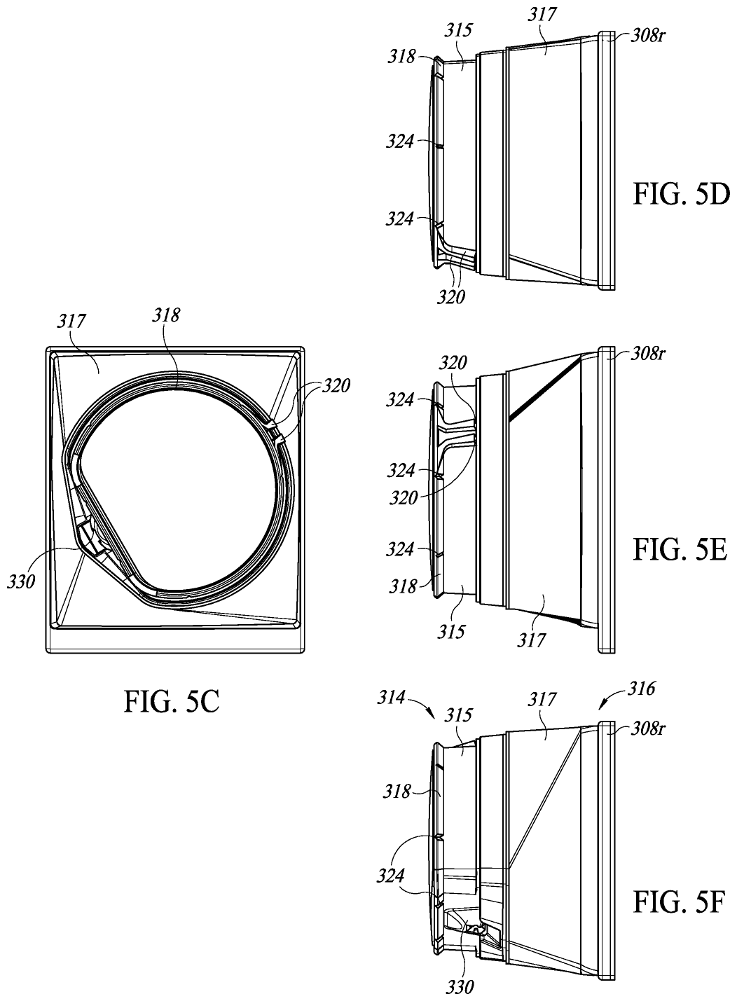

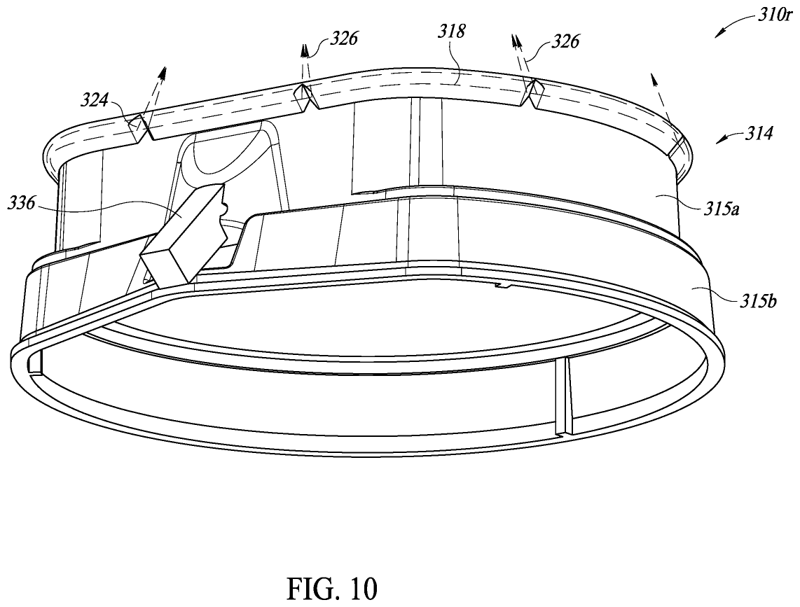

FIG. 5A to FIG. 10 show various views of an eye tracking system, including the right optical tube assembly 310r shown in FIG. 4, according to one or more non-limiting illustrated implementations. It should be appreciated that the left optical tube assembly 3101 may be substantially similar to (e.g., symmetrical) the right optical tube assembly 310r. Accordingly, the discussion below applies to both of the optical tube assemblies 3101 and 310r, where applicable.

As shown in FIGS. 5A and 5B, the lens assembly 312r is supported by the optical tube assembly 310r that is mechanically coupled to the lens assembly. The optical tube assembly 310r provides optical alignment between the lens assembly 312r and the display panel 308r of the HMD device 300. The lens assembly 312 is positioned proximate to a front end 314 of the optical tube assembly 310r that is relatively proximate a user's eye during use of the HMD device 300.

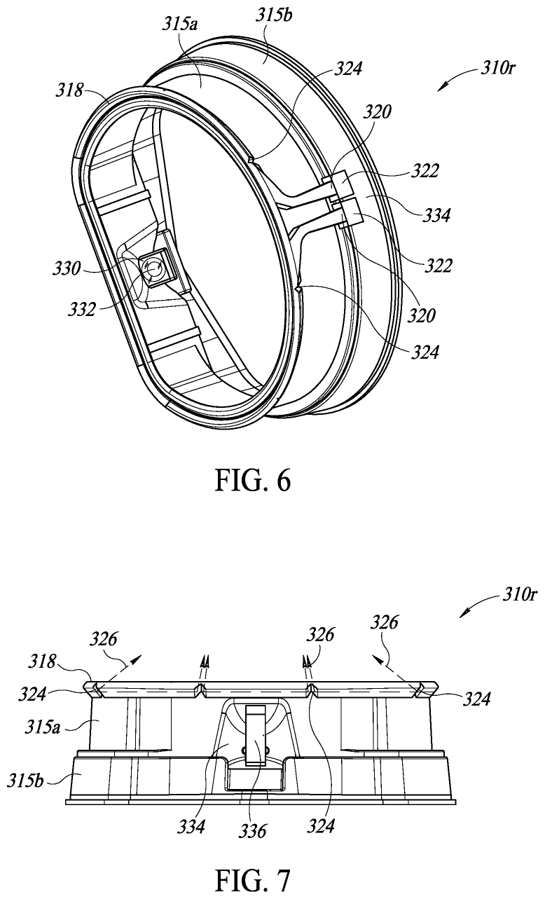

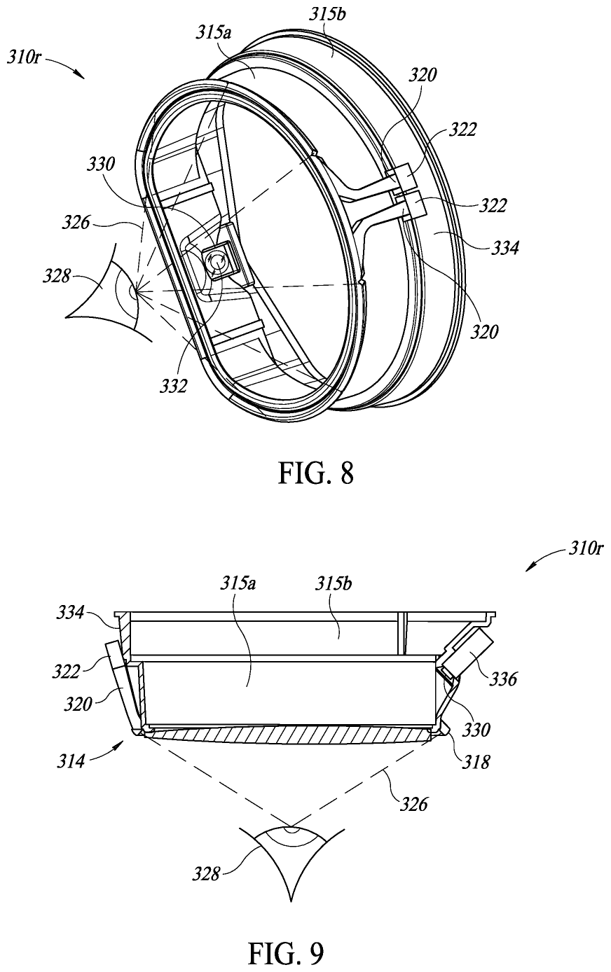

The system also includes an optical light guide 318 operative to transport light from one or more light sources to the user's eye for eye tracking purposes. The optical light guide 318 is mechanically coupled to the optical tube assembly 310r. The optical light guide 318 may include one or more light input features 320 (e.g., light input surfaces) that are positioned rearward of the front end 314 of the optical tube assembly 310r toward a back end 316 of the optical tube assembly. The one or more light input features 320 are configured to receive light from one or more light sources 322 (FIG. 6), which may be IR LEDs or other types of light sources. The optical light guide 318 also includes a plurality of light output features or surfaces 324 spaced apart from each other and positioned proximate to the front end 314 of the optical tube assembly 310r. Each of the light output features, which mays also be referred to as exit surfaces or exit apertures, is configured to allow light 326 inside the optical light guide 318 to exit the optical light guide toward the user's eye 328 (FIGS. 8 and 9) during use of the HMD device.

The output features 326 are specifically designed to allow light to efficiently leave the optical light guide 318 and to distribute the light in a desired manner, with a specific intensity, direction, or pattern. The output features 324 may be designed with specific geometries, textures, or coatings to modify the way light exits the optical light guide, further enhancing its distribution, uniformity, or overall shape. Thus, using only light sources that are positioned rearward of the front end 314, the optical light guide 318 provides multiple light output sources positioned around a periphery of the front end 314 which allow for detection (e.g., glint detection) by an optical sensor.

Implementations may include one or more of the following features. The optical light guide may be operative to transport light via total internal reflection (TIR). Each of the plurality of light output features 324 may include the same material as a remainder of the optical light guide 318, and may include a physical geometry, such as one or more appropriately angled surfaces, which allows light inside the optical light guide to exit the optical light guide at a precise angle toward the user's eye during use of the HMD device 300. In general, the optical light guide 318 may be made from one or more transparent materials that have high optical clarity, low absorption, and good light transmission properties. Some example materials that may be used for the optical light guides of the present disclosure include polycarbonate, polymethyl methacrylate, glass, or other suitable materials.

The optical tube assembly 310r may include an optical window or opening 330 that permits an optical sensor 336 positioned adjacent the window and outside the optical tube assembly to capture light reflected from the user's eye through the lens assembly 312r during operation of the HMD device 300. The optical window 330 may include a cover 332 (FIG. 8). In at least some implementations, the cover 332 is transparent to infrared light and is opaque to visible light. Similar to the optical light guide, the cover 332 may be formed to be part of the optical tube assembly 310r via a double shot injection molding process, for example.

The optical light guide 318 may include one or more light input features 320, wherein each of the light input features is configured to receive light from one or more light sources 322. As a non-limiting example, the light sources 322 may include IR LEDs coupled to a sidewall 334 of the optical tube assembly 310R. The optical tube assembly 310r may include a front end portion 315a and a rear end portion 315b, where the front end portion and the rear end portion are coupled together during manufacturing to form the optical tube assembly. In at least some implementations, the portions 315a and 315b are integrally formed.

The optical sensor 336 is positioned outside of the optical tube assembly proximate the optical window 330. The optical sensor 336 may be positioned so that the user's view of a display panel 308r of the HMD device 300 is not obstructed during operation.

The HMD device 300 may include one or more processors configured to receive the captured images from the optical sensor 336 and to analyze and determine the position and orientation of glints to determine the user's gaze direction.

One general aspect of the present disclosure includes a method for manufacturing an optical tube assembly, such as the optical tube assemblies discussed herein. The method may include positioning a mold within a dual-shot injection molding apparatus, the mold having a cavity defining the shape of an optical tube assembly. The method also includes injecting a first material into a mold cavity using a first injection unit, the first material configured to form a portion of the optical tube assembly and having properties suitable for structural support. The method also includes injecting a second material into the mold cavity using a second injection unit, the second material configured to form an optical light guide, such as any of the optical light guides discussed herein. The method also includes allowing the second material to solidify within the mold cavity, thereby fusing the first and send materials to form the optical tube assembly as a single, integrated component. Other embodiments of this aspect include forming an optical window or opening, and/or an optical cover, such as the optical window 330 and cover 332 discussed herein.

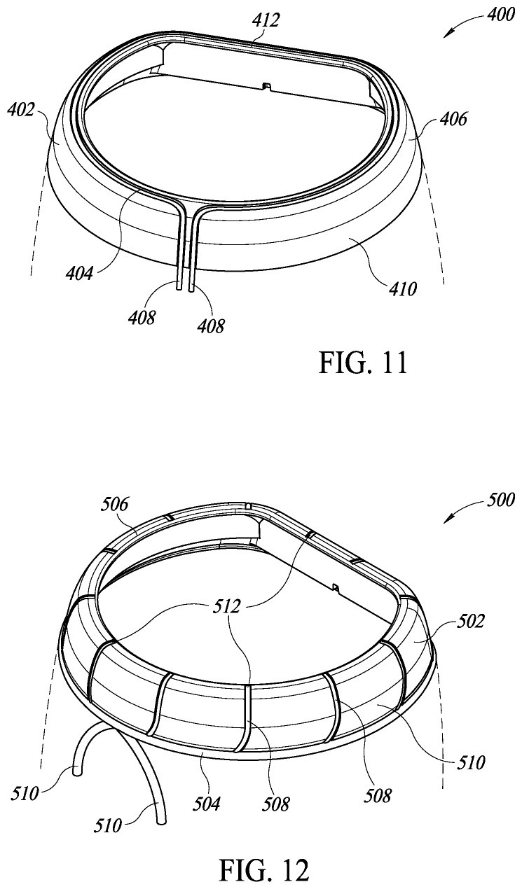

FIG. 11 is a perspective view of another embodiment of a front end portion of an optical tube assembly 400, according to one non-limiting illustrated implementation. The optical tube assembly 400 may be similar or identical to the optical tube assemblies 310 discussed above. Accordingly, only those features that are unique are discussed in the interest of brevity. The optical tube assembly 400 includes a sidewall 402 that includes a front end 406 that is proximate a user's eye when the user is wearing the HMD device, and a rear end 410 opposite the front end. The optical tube assembly 400 further includes an optical light guide 404 that is positioned within a recessed peripheral groove 412 that extends around the perimeter of the front end 406. The optical light guide 404 may include one or more input features 408, which are positioned toward the rear end 410. Similar to the output features 324 discussed above, the optical light guide 404 may include a plurality of output features spaced apart from each other around the periphery of the front end 406 of the optical tube assembly. The optical tube assembly 400 and the optical light guide 404 may be formed via dual-shot injection molding process.

FIG. 12 is a perspective view of another embodiment of a front end portion of an optical tube assembly 500, according to one non-limiting illustrated implementation. The optical tube assembly 500 may be similar or identical to the optical tube assemblies 310 and 400 discussed above. Accordingly, only those features that are unique are discussed in the interest of brevity. The optical tube assembly 500 includes a sidewall 502 that includes a front end 506 that is proximate a user's eye when the user is wearing the HMD device, and a rear end 510 opposite the front end. The optical tube assembly 500 further includes an optical light guide 504 that extends around the perimeter of the optical tube assembly proximate the rear end 510. The optical light guide 504 may include one or more input features 511, which are positioned toward the rear end 510. The optical light guide 504 includes a plurality of branches 508, each of the branches terminating with one of a plurality of light output features 512. The optical tube assembly 500 and the optical light guide 504 may be formed via dual-shot injection molding process, for example.

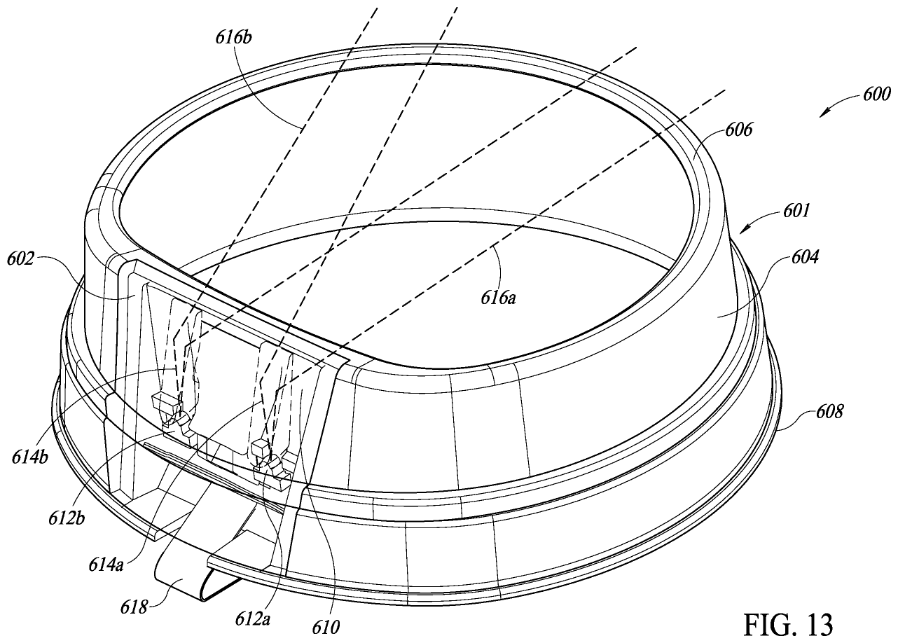

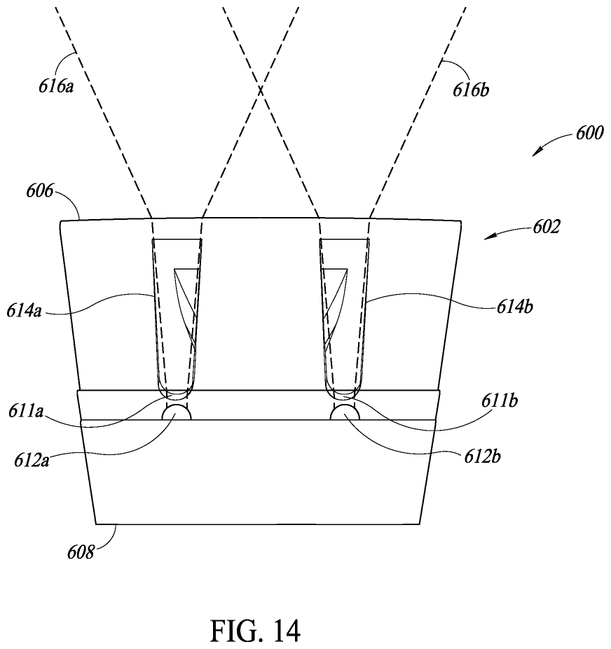

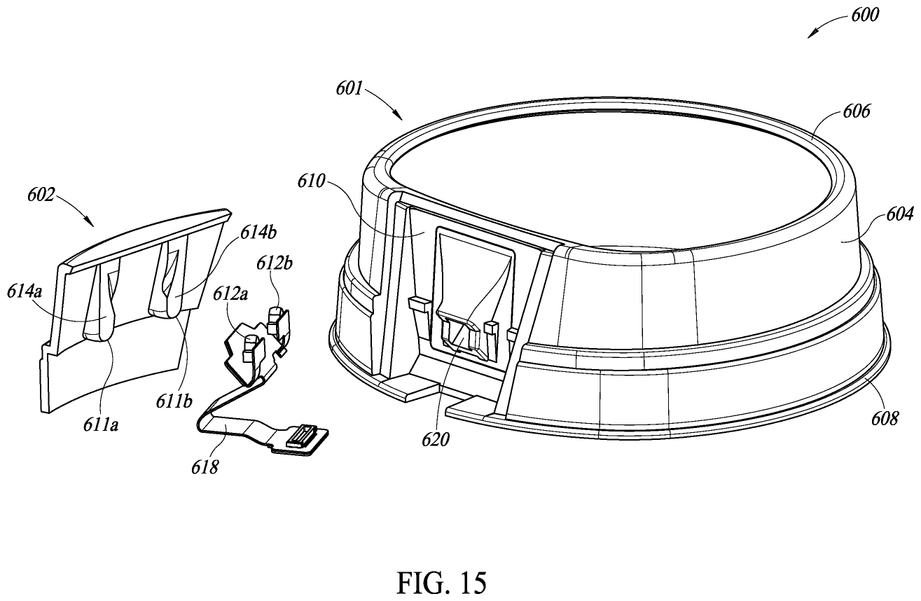

FIG. 13 is a perspective view of another embodiment of a front end of an optical tube assembly 600, according to one non-limiting illustrated implementation. FIG. 14 is an interior view of an optical light guide 602 of the optical tube assembly 600. FIG. 15 is a disassembled view of the optical tube assembly 600. Several aspects or features of the optical tube assembly 600 may be similar or identical to the optical tube assemblies 310, 400, and 500 discussed above. Accordingly, some or all of the discussion above may also apply to the optical tube assembly 600, where appropriate. The optical tube assembly 600 includes a main body 601 having a sidewall 604 that includes a front end 606 that is proximate a user's eye when the user is wearing the HMD device, and a rear end 608 opposite the front end. The optical tube assembly 600 further includes the optical light guide 602 that is fixedly or removably coupled to a side portion 610 of the main body 601.

The optical light guide 602 may include one or more light input features 611a and 611b, which are positioned distant from the front end 606 of the main body 601 adjacent light sources 612a and 612b, respectively. The light sources 612 (e.g., IR LEDs) may be connected to a flexible printed circuit board 618 or other suitable electrical connection. The light guide 602 includes elongated portions 614a and 614b that extend from the light input features 611a and 611b to the front end 606 of the main body 601 of the optical tube assembly. In operation, light 616a from the light source 612a is in-coupled at the input feature 611a, and travels through the elongated portion 614a toward the front end 606, where the light is directed toward the user's cye. Similarly, light 616b from the light source 612b is in-coupled at the input feature 611b, and travels through the elongated portion 614b toward the front end 606, where the light is directed toward the user's eye. The optical tube assembly 600 and the optical light guide 602 may be formed via dual-shot injection molding process, for example.

Similar to embodiments discussed above, the main body 601 of the optical tube assembly 600 may include an optical window or opening 620 (FIG. 15) that permits an optical sensor (not shown) positioned adjacent the window and outside the optical tube assembly to capture light reflected from the user's eye through the lens assembly (not shown) during operation of the HMD device. The optical window 620 may include a cover (e.g., cover 332 of FIG. 8). In at least some implementations, the cover is transparent to infrared light and is opaque to visible light. Similar to the optical light guide 602, the cover may be formed to be part of the optical tube assembly 600 via a double shot injection molding process, for example. In at least some implementations, the camera may be coupled to the same circuit board 618 as the light sources 612, wherein the camera is positioned to capture light reflected off the user's eye through the window 620.

From the foregoing it will be appreciated that, although specific embodiments have been described herein for purposes of illustration, various modifications may be made without deviating from the spirit and scope of the disclosure. In addition, while certain aspects of the disclosure are presented at times in certain claim forms, or may not be embodied in any claims at some times, the inventors contemplate the various aspects of the disclosure in any available claim form. For example, while only some aspects of the disclosure may be recited at a particular time as being embodied in a computer-readable medium, other aspects may likewise be so embodied.

What is claimed is:

1. An eye tracking system for a head-mounted display (HMD) device, comprising:
a lens assembly;
an optical tube assembly mechanically coupled to the lens assembly to support the lens assembly and to provide optical alignment between the lens assembly and a display panel of the HMD device, the lens assembly being positioned proximate to a front end of the optical tube assembly that is relatively proximate a user's eye during use of the HMD device; and
an optical light guide operative to transport light, the optical light guide being mechanically coupled to the optical tube assembly, the optical light guide comprising:
a light input feature that is positioned rearward of the front end of the optical tube assembly, the light input feature configured to receive light from one or more light sources; and
a plurality of light output features spaced apart from each other and positioned proximate to the front end of the optical tube assembly, each of the light output features configured to allow light inside the optical light guide to exit the optical light guide toward the user's eye during use of the HMD device.

2. The eye tracking system of claim 1, wherein the optical light guide is operative to transport light via total internal reflection (TIR).

3. The eye tracking system of claim 1, wherein each of the plurality of light output features comprises the same material as a remainder of the optical light guide, and includes a physical geometry that allows light inside the optical light guide to exit the optical light guide toward the user's eye during use of the HMD device.

4. The eye tracking system of claim 1, wherein the optical light guide is formed from at least one of polycarbonate, polymethyl methacrylate, or glass.

5. The eye tracking system of claim 1, wherein the optical tube assembly comprises an optical window that permits an optical sensor positioned outside the optical tube assembly to capture light reflected from the user's eye during operation of the HMD device.

6. The eye tracking system of claim 5, wherein the optical window is transparent to infrared light and is opaque to visible light.

7. The eye tracking system of claim 1, wherein the optical light guide comprises a plurality of light input features, each of the light input features configured to receive light from one or more light sources.

8. The eye tracking system of claim 1, further comprising a light source positioned adjacent the light input feature of the optical light guide.

9. The eye tracking system of claim 8, wherein the light source is mechanically coupled to an outer sidewall of the optical tube assembly.

10. The eye tracking system of claim 1 wherein the optical tube assembly comprises a front end portion and a rear end portion, wherein the front end portion and the rear end portion are coupled together to form the optical tube assembly.

11. The eye tracking system of claim 1, further comprising:
an optical sensor configured to capture images of the user's eye, wherein the optical sensor is positioned outside of the optical tube assembly.

12. They eye tracking system of claim 11, wherein the optical sensor is positioned so that the user's view of a display panel of the HMD device is not obstructed.

13. The eye tracking system of claim 1, further comprising:
a display panel positioned at a rear end of the optical tube assembly opposite the front end.

14. The eye tracking system of claim 1, further comprising:
a processor configured to receive the captured images from an optical sensor and to analyze the position and orientation of glints to determine the user's gaze direction.

15. The eye tracking system of claim 1, wherein the optical light guide includes a plurality of branches, each of the branches terminating with one of the plurality of light output features.

16. The eye tracking system of claim 1, wherein the optical tube assembly and the optical light guide are formed via dual-shot injection molding process.

17. A head-mounted display (HMD) system, comprising:
a support structure wearable on the head of a user;
first and second eye tracking subsystems coupled to the support structure, each of the first and second eye tracking subsystems comprising:
a lens assembly;
an optical tube assembly mechanically coupled to the lens assembly to support the lens assembly and to provide optical alignment between the lens assembly and a display panel of the HMD system, the lens assembly being positioned proximate to a front end of the optical tube assembly that is relatively proximate a user's eye during use of the HMD system; and
an optical light guide operative to transport light, the optical light guide being mechanically coupled to the optical tube assembly, the optical light guide comprising:
a light input feature that is positioned rearward of the front end of the optical tube assembly, the light input feature configured to receive light from one or more light sources; and
a plurality of light output features spaced apart from each other and positioned proximate to the front end of the optical tube assembly, each of the light output features configured to allow light inside the optical light guide to exit the optical light guide toward the user's eye during use of the HMD system.

18. The head-mounted display system of claim 17, wherein the optical tube assembly comprises an optical window that permits an optical sensor positioned outside the optical tube assembly to capture light reflected from the user's eye during operation of the HMD device.

19. A method for manufacturing an optical tube assembly, the method comprising:
positioning a mold within a dual-shot injection molding apparatus, the mold having a cavity defining the shape of an optical tube assembly;
injecting a first material into a mold cavity using a first injection unit, the first material configured to form a portion of the optical tube assembly and having properties suitable for structural support;
injecting a second material into the mold cavity using a second injection unit, the second material configured to form an optical light guide; and
allowing the second material to solidify within the mold cavity, thereby fusing the first and second materials to form the optical tube assembly as a single, integrated component.

20. The method of claim 19, further comprising:
injecting a third material into the mold cavity using a third injection unit, the third material configured to cover an opening in a sidewall of the optical tube assembly, and the third material being transparent to infrared light to form an optical window through the sidewall of the optical tube assembly.

21. An eye tracking system for a head-mounted display (HMD) device, comprising:
a lens assembly;
an optical tube assembly mechanically coupled to the lens assembly to support the lens assembly and to provide optical alignment between the lens assembly and a display panel of the HMD device, the lens assembly being positioned proximate to a front end of the optical tube assembly that is relatively proximate a user's eye during use of the HMD device; and
an optical light guide operative to transport light, the optical light guide being mechanically coupled to a sidewall of the optical tube assembly, the optical light guide comprising:
one or more light input features that are positioned rearward of the front end of the optical tube assembly, each of the one or more light input features configured to receive light from one or more light sources; and
one or more light output features positioned proximate to the front end of the optical tube assembly, each of the one or more light output features configured to allow light inside the optical light guide to exit the optical light guide toward the user's eye during use of the HMD device.

22. The eye tracking system of claim 21, wherein the optical light guide is operative to transport light via total internal reflection (TIR).

23. The eye tracking system of claim 21, wherein the optical light guide is formed from at least one of polycarbonate, polymethyl methacrylate, or glass.

24. The eye tracking system of claim 21, wherein the optical light guide is selectively removable from a main body of the optical tube assembly.

25. The eye tracking system of claim 21, wherein the optical tube assembly comprises an optical window that permits an optical sensor positioned outside the optical tube assembly to capture light reflected from the user's eye during operation of the HMD device.

26. The eye tracking system of claim 25, wherein the optical sensor is positionable between a main body of the optical tube assembly and the optical light guide.

27. The eye tracking system of claim 25, wherein the optical window is transparent to infrared light and is opaque to visible light.

28. The eye tracking system of claim 21, further comprising one or more light sources positioned adjacent respective ones of the one or more light input features.

29. The eye tracking system of claim 21, further comprising:
an optical sensor configured to capture images of the user's eye, wherein the optical sensor is positioned outside of the optical tube assembly.

30. The eye tracking system of claim 21, wherein the optical tube assembly and the optical light guide are formed via dual-shot injection molding process.
